(19) United States
(12) Patent Application Publication
(10) Pub. No.: US 2009/0076852 A1
(43) Pub. Date: Mar. 19, 2009

(54) SYSTEM AND METHOD FOR AN AUTOMATED PATIENT CONTROLLED SYSTEM OF HEALTH CARE PROVISION AND PATIENT MONITORING USING PERSONAL HEALTH RECORDS

(76) Inventors: Marc Pierson, Bellingham, WA (US); Nik Ivancic, Bellingham, WA (US); Roger Melen, Los Altos Hills, CA (US)

Correspondence Address: BLACK LOWE & GRAHAM, PLLC, 701 FIFTH AVENUE, SUITE 4800, SEATTLE, WA, 98104, US

(21) Appl. No.: 12/196,179

(22) Filed: Aug. 21, 2008

Related U.S. Application Data
(60) Provisional application No. 60/957,377, filed on Aug. 22, 2007.

(51) Int. Cl. G06Q 50/00

(52) U.S. Cl. 705/3

(57) ABSTRACT

A system to enable automated interactive provision of health care services by allowing selective remote monitoring of patient healthcare information. The system facilitating submission of patient health care instructions to a health care monitoring service, conversion of submitted health care instructions to a patient workflow template, and storage of the patient workflow template on a healthcare data server. The system further facilitating access to a patient workflow template in a healthcare data server with a shared care plan application interface, logging of patient workflow transactions related to a patient workflow template, and monitoring of logged patient workflow transactions with the health care monitoring service to determine if the patient health care instructions are being adhered to.

### PRIORITY CLAIM

This application incorporates by reference as if fully disclosed herein and claims priority to U.S. Patent Application Ser. No. 60/957,377 filed Aug. 22, 2007.

### BACKGROUND OF THE INVENTION

In the past, remote patient healthcare provision approaches suffer from lack of patient participation, incomplete data, poor communications, inaccurate time records, and slow response.

The prior art attempts to teach home healthcare while an institutional setting or after a patient is discharged from an institutional setting such as a hospital, extended care facility, or clinic. This is achieved by a combination of a verbal conference, written instructions and printed documents. Patients simply talk to the doctor and nurse before leaving the facility and receive a large amount of paperwork to read at home and in some cases receive prescriptions or other home remedies. Occasionally telephone calls were placed by the doctor, nurse or other healthcare professional to check up on the recovery progress of the patient

The prior art is error prone, requires costly time by healthcare professionals and the system has limited ability to ensure or monitor actual data of patient compliance. The health data information is created, owned and maintained by the healthcare provider, and the patient has very limited influence (if any) to fully monitor or alter his intended treatment. Treatment actions achieve only limited success because of lack of involvement, data and knowledge on the part of the patient and limited ability of providers to stay in communication with the patient and their home support network. Patient's spouse, neighbors, and relatives have limited influence or knowledge of the process. Patient confidentiality requires limits placed on access to patient information. Healthcare laws such as HIPPA place specific legal restrictions on the handling of patient data.

Prior art only enables establishing and sharing of partial patient records created by care providers and by the patient. Other Internet services establish email or electronic chat with health care providers or payers. There remains an unmet need in the art to enhance the quality of patient-controlled healthcare by achieving a consensus between provider, recipient, family and payers on a clearly defined set of actions shared between all parties with monitoring to enable evaluation of compliance observable by all authorized parties.

### SUMMARY OF THE INVENTION

In one embodiment, a network system to enable automated interactive provision of health care services to remote network patients is disclosed. The system includes, in one embodiment, a rule based messaging system (connected to digital voice, text, and human call center) responding to actionable data stored in a patient-alterable central file combined with a patient data collection system sensing patient data and automatic electronic sensors in the patient environment. A patient controls a list of allowed health care providers, and other groups including, but not limited to, individuals who may access and use patient records and their privileges. The patient provides a list of access privileges to specify which capabilities each group may utilize. All key transactions are logged, time-stamped and monitored to enable triggering derivative actions.

In one embodiment, a computer system stores and uses actionable data in a patient controlled healthcare record (personal health record—PHR) to provide necessary interactive services by the patient, friends, and healthcare providers. Actionable data in the PHR is combined with time-stamped logging of key transactions and a means for implementing data driven actions which are unique components of the systems.

In one embodiment, a network system is established by interactive consensus which provides communication, time-stamp-logging and monitoring, as well as patient probing, reminder and alert services for the remote treatment of patients in which the patient has primary control of his/her treatment and through control allowing or denying access and system privileges to specific users or groups is new.

In one embodiment, the system and method provides healthcare to patients as outpatients after being discharged from facilities such as hospitals, extended care facilities, and clinics. Patients, nurses, doctors, professional care managers, and network of friends are messaged following rules responsive to the patient's condition as indicated by his stored health records and responsive to the patients self monitored or device monitored behavior. This patient file rule-based automated capability allows for electronic communication, instead of, or in addition to written instruction supplied on paper to patients at time of discharge from residence within a care facility.

In one embodiment, the Internet and common networked server computers are used. Standard operating systems and commercial software modules provide basic computer workflow and data storage functionality of the system. Customized software modules enable unique system capabilities of the patient-centric, interactive, monitored, remote healthcare provision system. Standard computer network time servers provide accurate time codes for time stamping of monitoring, activity, communication, and transaction documents.

### BRIEF DESCRIPTION OF THE DRAWINGS

The preferred and alternative embodiments of the present invention are described in detail below with reference to the following drawings.

FIG. 1 is a flow diagram of one embodiment;

FIG. 2 represents the unified view of the workflows running in the Hospital and workflows running in the PHMS application, which is an instance of the Personal Health Record Bank;

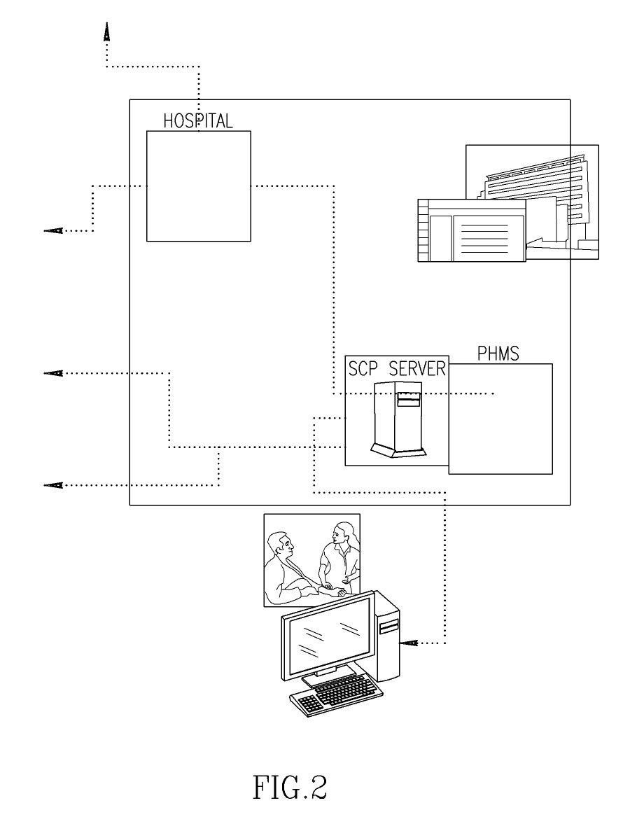

FIG. 3 is a detailed view into the interaction between two independent workflow systems;

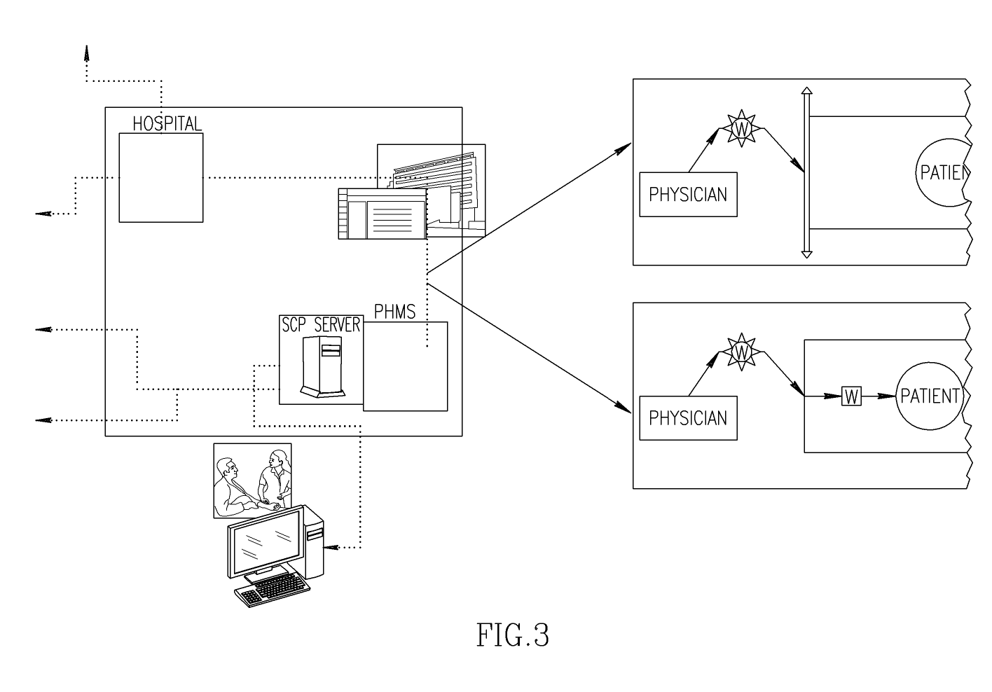

FIG. 4 is the Physician's User Interface in one embodiment;

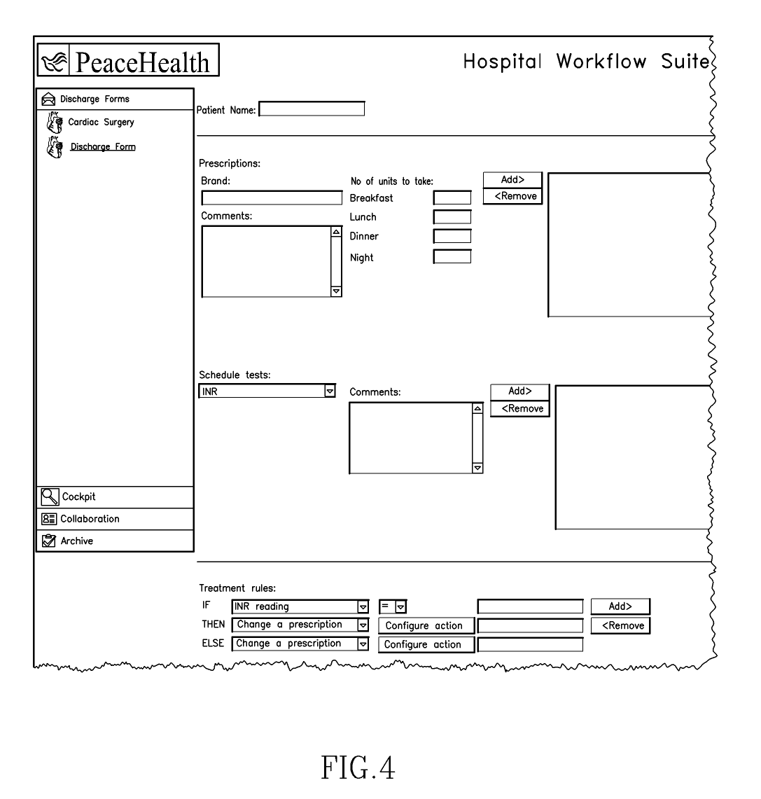

FIG. 5 is the Patient's User Interface in one embodiment;

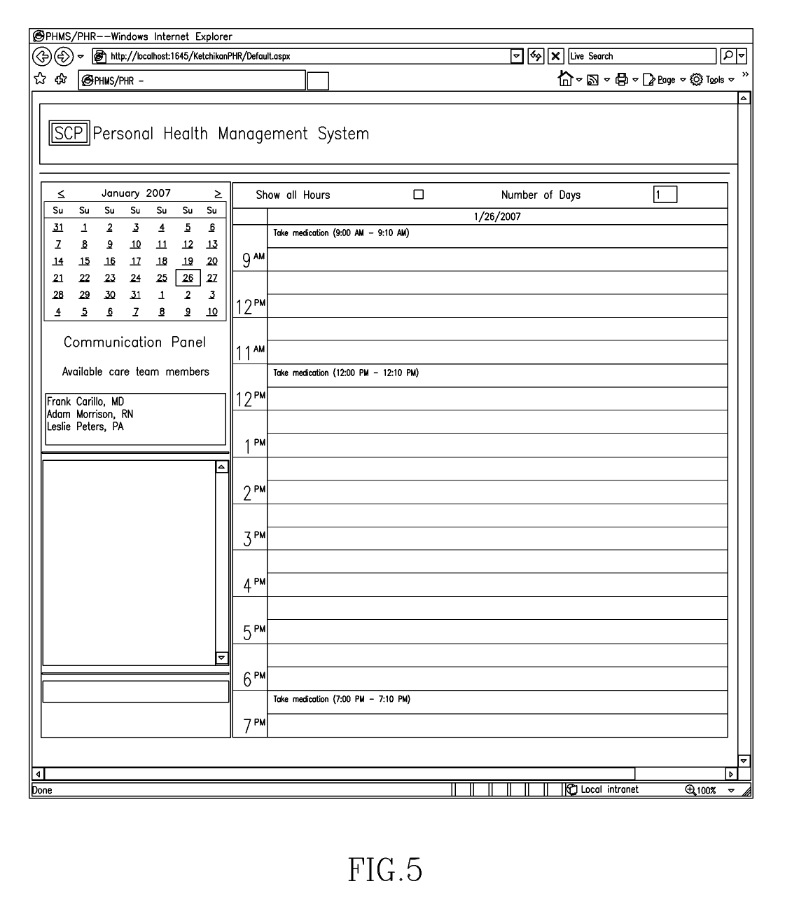

FIG. 6 shows personal health management framework main components in one embodiment;

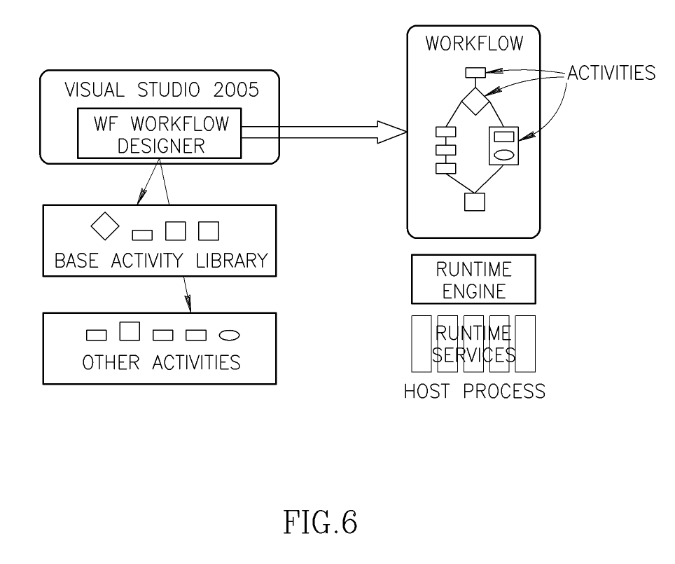

FIG. 7 shows a template loaded and executed by the Windows SharePoint Services-hosted PHMS Workflow runtime engine, creating a workflow instance in one embodiment;

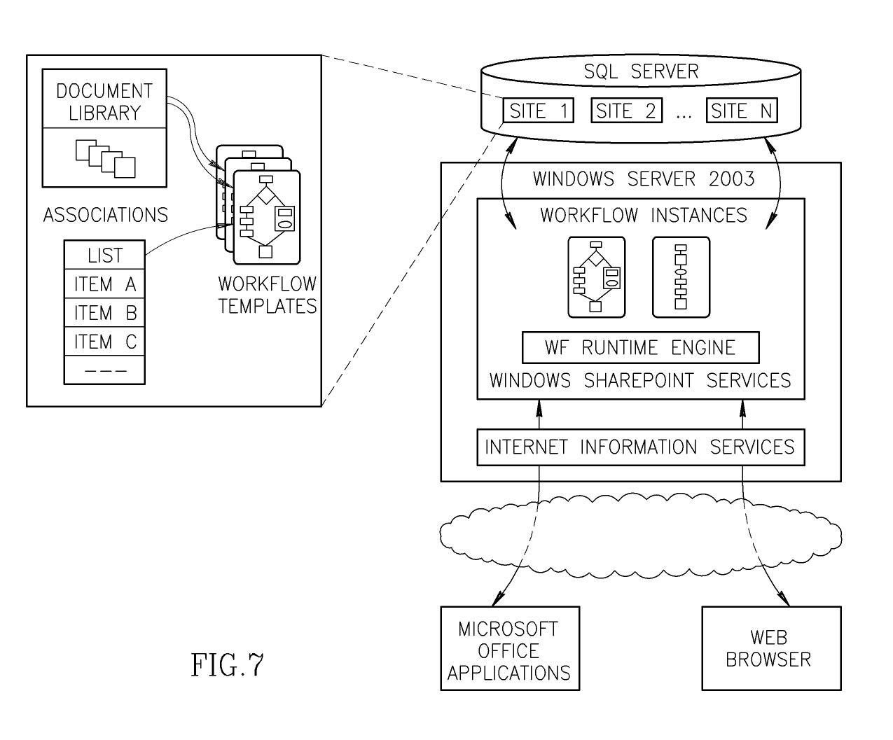

FIG. 8 shows what a typical physician might issue on discharge;

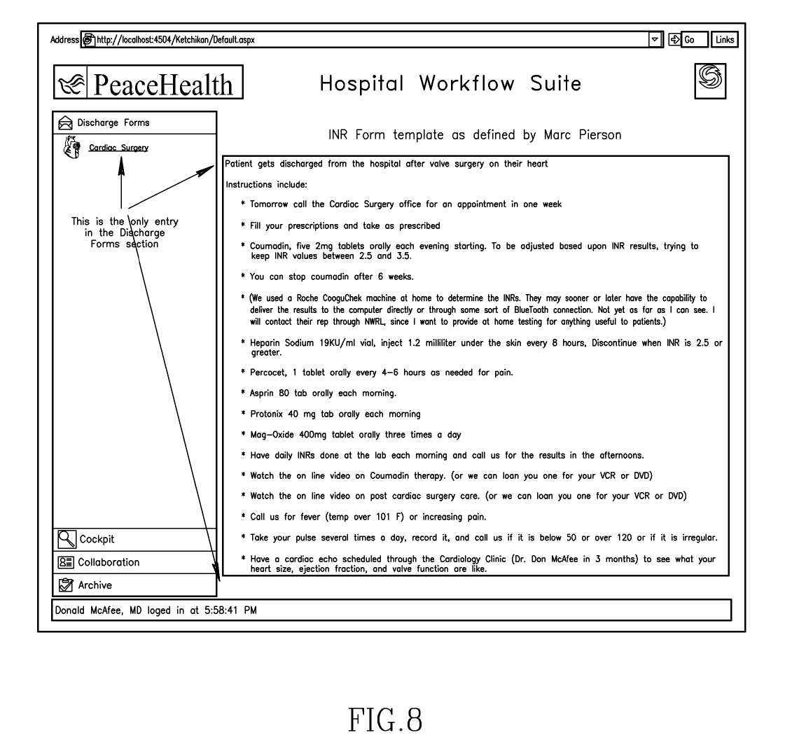

FIG. 9 is a screenshot of the actual users experience in one embodiment; and,

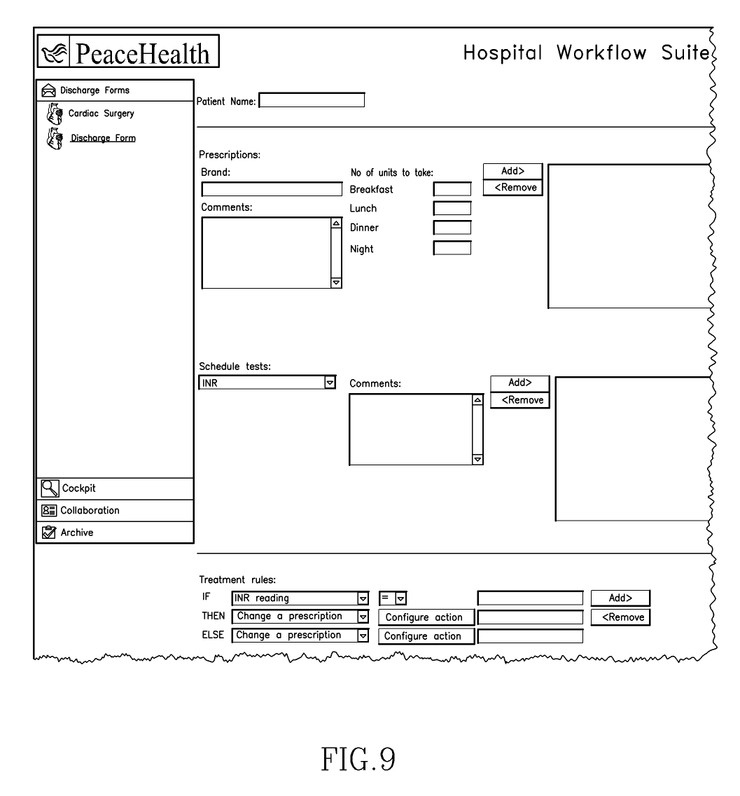

FIG. 10 is a rendering of participants in one embodiment.

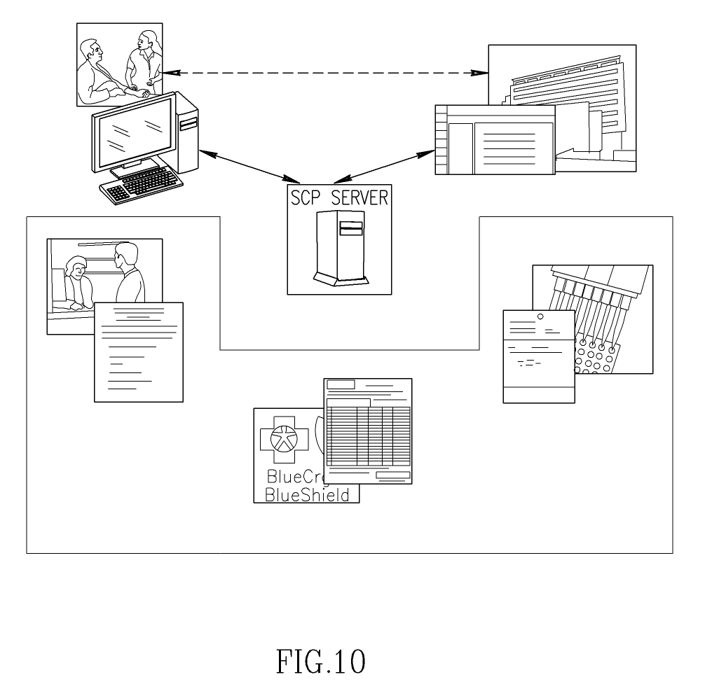

### DETAILED DESCRIPTION OF THE PREFERRED EMBODIMENT

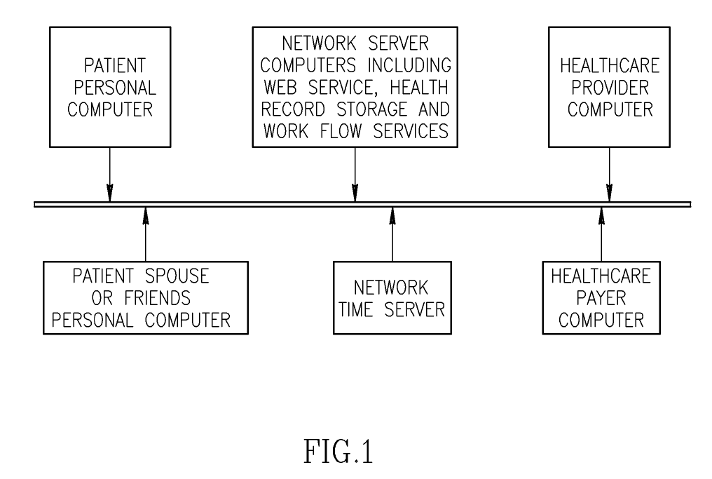

FIG. 1 shows a networked system using the Internet and common networked server computers providing services. Standard operating systems and commercial software modules provide basic computer workflow and data storage functionality of the system. Customized software modules enable unique system capabilities of the patient-centric, interactive, monitored, remote healthcare provision system. Standard computer network time servers provide accurate time codes for time stamping of monitoring, activity, communication, and transaction documents.

In one embodiment, a Personal Health Management System (“PHMS”) application framework seeks to transform the experiences of patients, their families, and healthcare professionals within the nation's and world's healthcare systems by leveraging the best knowledge in the domains of evidence-based medicine, user-centered collaborative technology, and healthcare quality improvement. PHMS enables individuals and families to knowledgeably manage their healthcare information, and to share that information in partnership with members of their healthcare teams to co-create, efficient, safe, and patient-centered healthcare in the context of PHMS based Shared Care Plan (SCP) application.

In a patient centered system, healthcare professionals collaborate with patients to develop treatment goals and plans, monitor their progress, and assess results in a continuous improvement-oriented cycle. The patient centered model takes into account all the needs of the patient, not just the physical and medical, but also their spiritual, emotional, and social needs—and it's the PHMS framework represented to the users via the PHR application that allows all these interactions.

In one embodiment, the SCP application built on top of PHMS framework, is equally capable of serving it's subscribers as well as other applications that are able to “play along” using Web Services API as a definition of the data exchange protocol. This property makes the PHMS SCP application an ideal candidate to serve as the hub which connects the patients with all other parties in the healthcare domain. In one embodiment, PHMS is built on top of ASP.NET 2.0, and subsequently on top of Windows SharePoint Services (WSS) 3.0, PHMS SCP can be linked with existing workflows running at the healthcare provider's infrastructure, and offer not yet seen optimizations in software assisted processes running in the context of the PHR. Similarly, this can be build on top of Microsoft's global Consumer Health Platform.

The PHMS Framework, in one embodiment, utilizes the concept of human workflows in order to facilitate the software assistance to healthcare processes executed in the context of Personal Health Management. This increases the process efficiency and lowers its error rate.

An application built with workflow consists of one or more workflows, each of which contains a determined number of activities. A workflow's activities are executed one at a time by workflow's runtime engine, with the execution order determined by the workflow itself. By providing direct support for process-oriented applications, workflow can make those applications easier to create and maintain.

In one embodiment the main component of the PHMS workflow include a workflow, built from activities, that executes using the runtime engine. This execution depends on a set of runtime services, provided by PHMS Workflow, that allow persisting a workflow's state, tracking its execution, and more. All of this runs inside some host, which can be any Windows process ranging from a simple desktop application to a scalable server. And to accommodate different requirements imposed by different hosts and different kinds of applications, the workflow runtime services can be replaced if necessary.

In order to maximize the leverage from the latest Microsoft technology delivered with Vista OS and made compatible with the existing versions of Windows XP and Windows Server 2003, PHMS framework, in one embodiment, uses Windows Share Point Services 3.0 as the hosting environment for the Workflow Engine. As a consequence, workflow templates (read: workflow programs dedicated to support specific processes) each containing the code that defines a particular workflow, can be installed on a server. Once this is done, an association can be created between a specific template and a document library, list, or content type. This template can then be loaded and executed by the Windows SharePoint Services-hosted PHMS Workflow runtime engine, creating a workflow instance.

In one exemplary embodiment, the shown on the workflow automation assisted process of patient's recovery after a complex surgery. Specifically, the standard patient discharge (paper) document, which defines the rules for the patient's behavior at home for the next few weeks, is being issued as an electronic form. This form is then automatically converted into an equivalent or more elaborate workflow template, which when activated, “guides” the patient throughout the home based recovery period, using the patient's PHR as the context. In addition the workflow originating process (driven by the physician's office staff, hospital staff, or extend care facility's staff), remains in constant connection with patient's context, receiving updates about all patient's scheduled tasks as well as events in case something unforeseen happened. In other words the TWFM module in PHMS system allows the healthcare professionals to view real time status of all discharged patients while they are in the recovery, using a cockpit-like web browser based view.

Further, an exemplary embodiment, demonstrates the usefulness of the Transition Workflow Management component of the PHMS framework, below is a typical discharge letter and how it relates with one embodiment of the system and method. Specifically, a typical discharge letter of the type: Patient gets discharged from the hospital after valve surgery on their heart. Instructions include: Tomorrow call the Cardiac Surgery office for an appointment in one week. Fill your prescriptions and take as prescribed Coumadin, five 2 mg tablets orally each evening starting. To be adjusted based upon INR results, trying to keep INR values between 2.5 and 3.5. You can stop Coumadin after 6 weeks. Heparin Sodium 19 KU/ml vial, inject 1.2 milliliter under the skin every 8 hours, Discontinue when IRN is 2.5 or greater.

Percocet, 1 tablet orally every 4-6 hours as needed for pain

Aspirin 80 tab orally each morning

Protonix 40 mg tab orally each morning

Mag-Oxide 400 mg tablet orally three times a day

Have daily INRs done at the lab each morning and call us for the results in the afternoons.

Watch the on line video on Coumadin therapy. (or we can loan you one for your VCR or DVD)

Watch the on line video on post cardiac surgery care. (or we can loan you one for your VCR or DVD)

Call us for fever (temp over 101 F) or increasing pain.

Take your pulse several times a day, record it, and call us if it is below 50 or over 120 or if it is irregular.

Have a cardiac echo scheduled through the Cardiology Clinic (Dr. Don McAfee in 3 months) to see what your heart size, ejection fraction, and valve function are like.

Instead of, or in addition to being printed and handed to the patient's family at the time of the patient's dismissal from the hospital, the same or more elaborate instructions, instantiated as an electronic form and filled with the instructions above, modified to the extent needed to comply with the form's formatting rules, is transmitted (via secure link to PHMS server) to the patient's “Data Bank.” In one embodiment, the contents and the semantics of the information contained in the discharge form is compiled into an XOML document—which is a complete definition of the workflow to be executed in the context of SCP application and which will interact with the patient in order to ensure patients compliance with physician's recommendations. The patient's experience of the workflow is envisioned as very natural for the given environment—a new interactive web page is added to the original SCP collection, which presents the overall calendar for the recovery period, with daily schedule presenting all prescribed activities. In addition, TWFM offers a direct communication channel with the healthcare professionals: All requests that have periodical character (take this prescription each second day in the morning evening) are presented to the patient in the form of a schedule, with remainders driven by the PHMS workflow, which has the ability to deal with non-compliance in many different ways, specified by the workflow rules. This includes the vocal and visual “nags”, all the way to reporting to the healthcare professionals that the patient does not seem to have taken the medicine.

In one embodiment, the workflow will also directly communicate to the healthcare professionals the results of all requested measurements that can be taken in context of patient's home. Finally the Communications Panel interface allows direct communications with healthcare professional, where the built in rules engine can “escalate” the urgency level and use different channels (Chat, SMS, etc)

PHMS framework is organized as a collection of shared libraries (DLLs) structurally dependent on the following technologies, these technologies represent some but not all that may be used in one embodiment of the system and method:

ASP.NET 2.0

Windows Share Point Services 3.0

Windows Share Point Server 2007

InfoPath Office 2007

Windows Workflow Foundation

Windows Communication Foundation

PingIdentity PingFederation

ADAM/Azman

Microsoft Consumer Health Platform

Functionally, PHMS is designed to assist processes and communications between various parties in healthcare domain. The proposed TWFM application focuses on a subset of participants (patients, their non-professional support network, and healthcare professionals). Thus TWFM is a loosely connected system of two or more Web Based distributed applications, which are synchronized in the context of the Shared Care Plan environment. PHMS in this situation acts as the mediator between the institutional workflow (which handles the patients discharge process) and a number of various workflows that run on the account of the patient in the context of the Shared Care Plan environment.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for monitoring patient healthcare information comprising:
submitting patient health care instructions to a health care monitoring service;
converting the submitted health care instructions to a patient workflow template;
saving the patient workflow template to a healthcare data server;
accessing the patient workflow template in the healthcare data server with a shared care plan application interface;
logging patient workflow transactions related to the patient workflow template into the shared care plan application interface; and
monitoring logged patient workflow transactions with the health care monitoring service to determine if the patient health care instructions are being adhered to.
